(19) United States
(12) Patent Application Publication
(10) Pub. No.: US 2015/0040636 A1
(43) Pub. Date: Feb. 12, 2015

(54) WIRE ROD AND STEEL WIRE FOR SPRINGS HAVING HIGH CORROSION RESISTANCE, METHOD OF MANUFACTURING STEEL WIRE FOR SPRINGS, AND METHOD OF MANUFACTURING SPRINGS

(71) Applicant: POSCO, Pohang-si, Gyeongsangbuk-do (KR)

(72) Inventors: Sang-Woo Choi, Pohang-si (KR); Soo-Dong Park, Pohang-si (KR)

(21) Appl. No.: 14/365,407

(22) PCT Filed: Dec. 20, 2012
(86) PCT No.: PCT/KR2012/011173

§ 371 Date: Jun. 13, 2014

(30) Foreign Application Priority Data
Dec. 23, 2011 (KR) 10-2011-0141290

(51) Int. Cl. C22C 38/38; C22C 38/02; B21C 1/00; C22C 38/34

(52) U.S. Cl. CPC C22C 38/38; C22C 38/34; C22C 38/02; B21C 1/00; F16F 1/021
USPC 72/274; 420/72; 420/74

(57) ABSTRACT

Provided is a rod wire and a steel wire for a spring having superior corrosion resistance, the rod wire and the steel wire comprising, by weight %, 0.45 to 0.6% of C, 17.0 to 25.0% of Mn, the remainder being Fe and other inevitable impurities. Also provided is a method for manufacturing a steel wire for a spring having superior corrosion resistance by drawing the rod wire, the steel wire having a tensile strength of 1800 to 2100 MPa and a reduction of area of 25% ore more. Also provided is a method for manufacturing a spring having superior corrosion resistance, comprising the steps of drawing the rod wire so as to obtain steel wire having a tensile strength 1800 to 2100 MPa and a reduction of area of 25% or more; and a step of cold-forming the steel wire at room temperature. According to the present invention the necessity of using expensive alloy elements is eliminated, and a QT heat-treatment process and a surface ferrite decarburization process are omitted to reduce costs, and a rod wire for a spring, a steel wire for a spring, and a spring having superior corrosion characteristics may be obtained.

### TECHNICAL FIELD

The present disclosure relates to a wire rod and steel wire for springs having high corrosion resistance, a method of manufacturing a steel wire for springs having high corrosion resistance, and a method of manufacturing springs having high corrosion resistance.

### BACKGROUND ART

In the case that the weight of automotive steel members is reduced in order to improve the fuel efficiency of automobiles, the safety of such automobiles may not be guaranteed, as loads able to be supported by unit weight of automotive steel members is fixed. Therefore, prior to reducing the weight of automotive components, the development of high-strength materials is required.

However, high-strength components may undergo a decrease in toughness due to grain boundary embrittlement, fractures at an early stage of machining or use, and early fractures caused by corrosion fatigue. Therefore, high-strength materials for automotive members, springs, and automotive components are also required to have high degrees of toughness and corrosion fatigue resistance.

For example, in Japanese Patent Application Laid-open Publication No.: 1998-110247, boron is used as an alloying element for improving fatigue characteristics and resistance to hydrogen embrittlement.

Chemical compositions of spring steels are specified in standards such as JIS G 4801, ISO 683-14, BS 970 part2, DIN 17221, SAE J 403, and SAE J 404. Hot-rolled steels having chemical compositions specified in such standards may be subjected to a peeling or drawing process, a series of thermoforming, quenching, and tempering processes or a series of a drawing process for obtaining a desired wire diameter and an oil-tempering process, and finally a spring forming process (a cold forming process), so as to manufacture various types of spring.

According to a technique of the related art, the corrosion fatigue resistance of springs is improved by increasing the number and amounts of alloying elements. In general, Cr is known as an element commonly used in improving corrosion resistance of springs. However, based on salt spray cycle test results, it has been reported that the corrosion resistance of springs is decreased by the addition of Cr. In a method addressing this problem, the content of Cr is limited to 0.25% or less, and the ratio of the contents of Cr and Cu+Ni are appropriately adjusted. In the method, the corrosion resistance of springs is improved due to a Cu and Ni rich layer being formed on the surfaces of the springs as a result of environmental corrosion. However, since springs are exposed to ambient environments for a predetermined period of time, and an inevitable amount of corrosion takes place therein, pits may be formed in the surfaces of the springs, and thus the fatigue-resistance characteristics of the springs may deteriorate.

Meanwhile, in the related art, methods of adding alloying elements and methods of lowering tempering temperatures are known as techniques for improving the strength of steel. For example, alloying elements such as C, Si, Mn, and Cr may be added to steel to increase the strength thereof, or relatively expensive alloying elements such as Mo, Ni, V, Ti, and Nb may be added and a quenching and tempering (QT) treatment may be performed to increase the strength of steel. However, these methods increase manufacturing costs and require an additional process for removing a decarburized ferritic layer, as ferrite remaining after a QT treatment increases the formation of corrosion pits. Furthermore, double coatings or protection films may be formed on springs to protect the springs from ambient environments. However, after a long period of use, such double coatings or protection films may fail, and corrosion fatigue factures may occur.

Furthermore, the strength of steel may be increased without varying the amounts of alloying elements in the steel by adjusting heat treatment conditions of the steel. For example, if a tempering process is performed on steel at a low temperature, the strength of the steel may be increased. In this case, however, the steel may have a low degree of reduction of area and a low degree of toughness. Therefore, the steel may be fractured during a spring forming process, or springs formed of the steel may be fractured at an early stage of use.

### DISCLOSURE

### Technical Problem

Aspects of the present disclosure may provide a wire rod and steel wire for springs having high corrosion resistance without using relatively expensive alloying elements.

Aspects of the present disclosure may also provide a method of manufacturing a steel wire for springs and a method of manufacturing springs. In these methods, although a quenching and tempering (QT) treatment and a process for removing a decarburized ferritic surface layer are not performed, the formation and growth of corrosion pits may be prevented to allow a spring steel wire and springs having high corrosion resistance to be realized.

Aspects of the present disclosure are not limited thereto. Additional aspects will be set forth in part in the description which follows, and will be apparent from the description to those of ordinary skill in the related art.

### Technical Solution

According to an aspect of the present disclosure, a wire rod for springs having high corrosion resistance may include, by weight %, 0.45% to 0.6%, Si: 1.0% to Mn: 17.0% to 25.0%, and the balance of Fe and inevitable impurities.

According to another aspect of the present disclosure, a steel wire for springs having high corrosion resistance may include, by weight %, C: 0.45% to 0.6%, Si: 1.0% to 3.0%, Mn: 17.0% to 25.0%, and the balance of Fe and inevitable impurities.

According to another aspect of the present disclosure, a method of manufacturing a steel wire for springs having high corrosion resistance may include drawing the wire rod to form a steel wire having a tensile strength of 1800 MPa to 2100 MPa and a reduction of area of 25% or greater.

According to another aspect of the present disclosure, a method of manufacturing springs having high corrosion resistance may include: drawing the wire rod to form a steel wire having a tensile strength of 1800 MPa to 2100 MPa and a reduction of area of 25% or greater; and cold working the steel wire at room temperature.

### Advantageous Effects

According to aspects of the present disclosure, a spring wire rod and spring steel wire that are inexpensive and have high corrosion resistance may be obtained without using relatively expensive alloying elements.

According to other aspects of the present disclosure, a quenching and tempering (QT) treatment may not be performed, decreasing manufacturing costs, and a process for removing decarburized ferritic surface layer may not be performed due to the formation of the layer being prevented.

### DESCRIPTION OF DRAWINGS

FIG. 1 is an image showing the depth of corrosion pits formed in a wire rod of an inventive example.

FIG. 2 is an image showing the depth of corrosion pits formed in a wire rod of a comparative example.

### BEST MODE

Hereinafter, a wire rod and steel wire for springs having high corrosion resistance, and methods of manufacturing a spring steel wire and springs having high corrosion resistance will be described in detail according to embodiments of the present disclosure, so as to provide clear understanding of the scope and spirit of the embodiments of the present disclosure to those of ordinary skill in the related art.

An embodiment of the present disclosure provides a wire rod for springs having high corrosion resistance, the wire rod including, by weight %, C: 0.45% to 0.6%, Si: 1.0% to 3.0%, Mn: 17.0% to 25.0%, and the balance of Fe and inevitable impurities.

The numerical ranges of the contents of the elements are set for reasons to be described below. In the following description, the content of each element is given in weight % unless otherwise specified.

C: 0.45% to 0.6%

Carbon stabilizes austenite and facilitates the formation of austenite at room temperature. Particularly, carbon lowers austenite-to-martensite deformation temperatures Ms and Md during a cooling process or a working process. In detail, Ms is a martensite transformation start temperature, and Md is a deformation-induced martensite transformation start amount. In addition, carbon included in a spring increases the strength of the spring. In order to obtain these effects, it may be preferable for the content of carbon be 0.45% or greater. However, if the content of carbon is greater than 0.6%, work hardening may increase to cause problems such as cracking and breakage, a markedly-shortened fatigue life, an increase in defect sensitivity, and formation of corrosion pits leading to a steep decline in fatigue life and breaking stress.

Si: 1.0% to 3.0%

Silicon dissolved in the microstructure of the wire rod. increases the strength of the wire rod and improves deformation resisting characteristics However, if the content of silicon is lower than 1.0%, the above-mentioned effects may not be sufficient. Therefore, the lower limit of the content of silicon is set to be 1.0% On the other hand, if the content of silicon is greater than 3.0%, the effect of improving deformation resisting characteristics is saturated, and surface decarburization is caused. Therefore, it may be preferable that the content of silicon be within the range of 1.0% to 3.0%.

Mn: 17,0% to 25.0%

Manganese is a main element for stabilizing austenite in high manganese steel like the wire rod of the embodiment of the present disclosure. in the embodiment of the present disclosure, preferably, the content of manganese may be set to be 17% or greater for stabilizing austenite when the content of carbon is within the above-mentioned range. If the content of manganese is lower than 17%, austenite as a main microstructure becomes unstable at room temperature, and thus a desired fraction of austenite may not be obtained. On the other hand, if the content of manganese is greater than 25%, work hardening may increase to cause problems such as cracking and breakage, a markedly-shortened fatigue life, an increase in defect sensitivity, and a steep decline in fatigue life and breaking stress caused by the formation of corrosion pits. Therefore, it may be preferable that the upper limit of the content of manganese be set to be 25.0%.

In the embodiment of the present disclosure, the other component of the wire rod is iron (Fe). In addition, impurities in raw materials or in manufacturing environments may be inevitably included in the wire rod, and thus such impurities may not be removed from the wire rod. Such impurities are well-known to those of ordinary skill in the steel manufacturing industry, and thus descriptions thereof will not be given in the present disclosure.

Furthermore, the wire rod may have a Cr content of 0.01% to 1.0% by weight.

Cr: 0.01% to 1.0%

Cr a useful element for improving oxidation resistance and quenching characteristics. However, if the content. of Cr is lower than 0.01%, oxidation resistance and quenching characteristics may be insufficiently improved. On the other hand, if the content of Cr is greater than 1.0%, deformation resistance characteristics may deteriorate, and thus the strength of the wire rod may be decreased. Therefore, it may be preferable that the content of Cr be within the range of 0.01% to 1.0%.

The wire rod having the above-described composition. may be improved in terms of the stability of austenite at room temperature owing to the high content of Mn and thus may have a desired austenite fraction in the microstructure thereof. In addition, the wire rod may be improved in wiredrawing characteristics owing to a high degree of elongation of austenite, and the strength of the wire rod may be sufficiently increased after the wire rod undergo only a wire drawing process. Thus, an additional quenching and tempering (QT) treatment may not be performed on the wire rod to increase the strength of the wire rod. The expression “austenite is stabilized” means that austenite is present at room temperature.

In the embodiment of the present disclosure, the wire rod has austenite as a main microstructure, It may be preferable that the wire rod include 99 volume % or more of austenite. In this case, the wire rod may have a high degree of workability. The wire rod may include 1 volume % or less of other microstructures such as ferrite, pearlite, martensite, bainite, various precipitates, and inclusions. In the embodiment of the present disclosure, austenite is intended to be formed as a main microstructure of the wire rod, and it may be preferable that the wire rod include 100 volume % of austenite, Therefore, the upper limit of the volume fraction of austenite in the wire rod is not set.

In addition, the formation of ferrite in a surface layer of the wire rod caused by a QT treatment may be prevented, and thus an additional process (peeling process) may not be required to remove a decarburized ferritic surface layer.

In addition, Mn and Cr added to the wire rod may increase the pH of the surface of the wire rod, and thus the formation and growth of corrosion, pits may be suppressed, thereby improving the corrosion resistance of the wire rod. In the related art, elements such as Nb, Ti, B, Ni, Cu, and Mo are added to improve corrosion fatigue characteristics of steel. However, according to the embodiment of the present disclosure, although such relatively expensive elements are not used, the wire rod may have sufficient resistance to corrosion and fatigue. In addition, according to the embodiment of the present disclosure, an additional surface treatment process may not be necessary.

The wire rod may be manufactured according to a general wire rod manufacturing method by performing reheating, hot-rolling, and cooling processes on billets having the above-described composition.

Another embodiment of the present disclosure provides a steel wire for springs having the same composition as that of the above-described wire rod.

The numerical ranges of the contents of the elements of the steel wire are set based on the same reasons as those described in the previous embodiment.

In some embodiments of the present disclosure, the steel wire may have a composite microstructure of modified austenite and martensite. However, the embodiments of the present disclosure are not limited thereto.

The expression “modified martensite” refers to austenite modified by a wire drawing process. The composite microstructure of modified austenite and martensite may be formed as some austenite changes into martensite during a drawing process (deformation- or stress-induced transformation). Since austenite is unstable at room temperature, Mn is added to stabilize austenite at room temperature and suppress the growth of corrosion pits in the wire rod or spring after a manufacturing process. As the degree of deformation in a drawing process is increased, some austenite may be changed into martensite by stress-induced transformation.

Another embodiment of the present disclosure provides a method of manufacturing a steel wire for springs having high corrosion resistance, the method including drawing the above-described wire rod to form a steel wire having a tensile strength of 1800 MPa to 2100 MPa and a reduction of area of 25% or greater.

The drawing process is performed on the wire rod to manufacture springs. The amount of drawing in the drawing process may be appropriately controlled so that the steel wire may have a tensile strength of 1800 MPa to 2100 MPa and a reduction of area of 25% or greater.

The tensile strength of 1800 MPa to 2100 MPa and the reduction of area of 25% or greater are mechanical properties required for general steel wires for springs. Since it is useless to specify the upper limit of the reduction of area of the steel wire, the upper limit of the steel wire is not set.

A QT treatment is not performed. This is different from technology of the related art. Sufficient strength, ductility, and corrosion resistance may be obtained although a QT treatment is not performed.

Another embodiment of the present disclosure provides a method of manufacturing a spring having high corrosion resistance, the method including; drawing the above-described wire rod to form a steel wire having a tensile strength of 1800 MPa to 2100 MPa and a reduction of area of 25% or greater; and cold-working the steel wire at room temperature.

The wire rod is drawn in a cold-working state, and then is deformed into a coil or spring shape in cold-working conditions so as to form springs. Thereafter, the springs are subjected to a stress relaxing heat treatment at 150° C. or higher.

### MODE FOR INVENTION

Hereinafter, the embodiments of the present disclosure will be described more specifically through examples. However, the examples are for clearly explaining the embodiments of the present disclosure and are not intended to limit the spirit and scope of the present disclosure.

### Examples

Slabs having compositions shown in Table 1 below were manufactured through a series of hot-rolling and cooling processes. In Table 1, the content of each element is given in weight %.

TABLE 1

| No. | C | Si | Mn | Cr |
|---|---|---|---|---|
| Comparative Steel 1 | 0.39 | 0.3 | 15.0 | — |
| Comparative Steel 2 | 0.9 | 0.7 | 16.0 | — |
| Comparative Steel 3 | 0.2 | 3.5 | 27.0 | 1.2 |
| Comparative Steel 4 | 0.8 | 3.7 | 28.5 | 1.5 |
| Comparative Steel 5 | 0.25 | 0.8 | 14 | 1.7 |
| Comparative Steel 6 | 0.95 | 0.3 | 13.5 | 1.6 |
| Inventive Steel 1 | 0.5 | 1.5 | 18 | 0.2 |
| Inventive Steel 2 | 0.55 | 1.8 | 19 | 0.3 |
| Inventive Steel 3 | 0.48 | 2.2 | 21 | 0.5 |
| Inventive Steel 4 | 0.52 | 2.5 | 23 | 0.6 |
| Inventive Steel 5 | 0.57 | 1.4 | 18.5 | 0.8 |
| Inventive Steel 6 | 0.46 | 2.7 | 24 | 0.9 |

Austenite fractions of wire rods formed of comparative steels and inventive steels of Table 1 were measured. Thereafter, the wire rods were drawn by the same amount (50%) so as to form steel wires, and the strength, reduction of area, and modified austenite fraction of each of the steel wires were measured. In addition, after a salt-water corrosion test, the depths of corrosion pits formed in the steel wires were measured. Results of the measurements are shown in Table 2.

TABLE 2

| | | Steel wire (spring) after wire drawing | | | | |
|---|---|---|---|---|---|---|
| | Wire rod | | Reduc- | Modified | | |
| | Austenite | Tensile | tion | austenite | Corrosion | |
| | fraction | strength | of area | fraction | pit depth | |
| No. | (%) | (MPa) | (%) | (%) | (mm) | Notes |
| *CS1 | 95 | 1640 | 31 | 95 | 0.07 | |
| CS2 | 96 | 1950 | 30 | 96 | 0.08 | wire |
| | | | | | | breakage |
| CS3 | 99 | 1850 | 10 | 98 | 0.055 | wire |
| | | | | | | breakage |
| CS4 | 98 | 1930 | 12 | 97 | 0.06 | wire |
| | | | | | | breakage |
| CS5 | 97 | 1670 | 32 | 97 | 0.06 | |
| CS6 | 99 | 1700 | 17 | 99 | 0.067 | wire |
| | | | | | | breakage |
| **IS1 | 99.5 | 1850 | 31 | 99 | 0.03 | |
| IS2 | 100 | 1950 | 33 | 100 | 0.035 | |
| IS3 | 99 | 1900 | 36 | 100 | 0.035 | |
| IS4 | 100 | 2050 | 28 | 99 | 0.037 | |
| IS5 | 100 | 2000 | 36 | 100 | 0.04 | |
| IS6 | 99.5 | 2020 | 34 | 100 | 0.035 | |

*CS: Comparative Steel,
**IS: Inventive Steel

Referring to Tables 1 and 2, Comparative Steel 1 has a composition different from that proposed in the embodiments of the present disclosure. That is, the contents of carbon and manganese stabilizing austenite are insufficient in Comparative Steel 1. Thus, when Comparative Steel 1 was used, a desired austenite fraction and mechanical characteristics were not obtained.

Comparative Steel 2 has a composition different from that proposed in the embodiments of the present disclosure. That is, the content of manganese stabilizing austenite is insufficient in Comparative Steel 2, and the content of carbon is excessive in Comparative Steel 2. Therefore, 96 volume % or less of austenite was formed, and thus a desired microstructure and strength were not obtained.

Comparative Steel 3 has a composition different from that proposed in the embodiments of the present disclosure. That is, the contents of carbon and manganese stabilizing austenite are outside of the ranges proposed in the embodiments of the present disclosure. Therefore, unstable austenite was formed, and the reduction of area of the steel wire (spring) formed of Comparative Steel 3 was less than 25 because of an excessive content of manganese. In addition, wire breakage was observed during a wire drawing process.

Comparative Steel 4 has an excessive carbon content and an excessive manganese content. Therefore, after a wire drawing process, the steel wire (spring) formed of Comparative Steel 4 undergone excessive work hardening, and thus the reduction of area thereof was less than 25%. Wire breakage was also observed in the wire drawing process. That is, a desired microstructure and strength were not obtained.

The contents of carbon and manganese of Comparative Steel 5 are outside of the ranges proposed in the embodiments of the present disclosure. Therefore, the austenite fraction of a wire rod formed of Comparative Steel 5 was less than 99%. That is, a desired microstructure was not obtained. In addition, mechanical characteristics thereof were also out of desired ranges.

Comparative Steel 6 has an insufficient manganese content and an excessive carbon content. Therefore, after a wire drawing process, the degree of tensile strength was lower than a desired range, and due to high work hardening, wire breakage was observed in the wire drawing process.

However, when Inventive Steels 1 to 6 having compositions according to the embodiments of the present disclosure were used, 99 volume % or more of austenite was obtained, and high tensile strength and reduction of area were obtained. In addition, the depths of corrosion pits in the steel wires formed of the inventive steels were smaller than the depths of corrosion pits in the steel wires formed of the comparative steels.

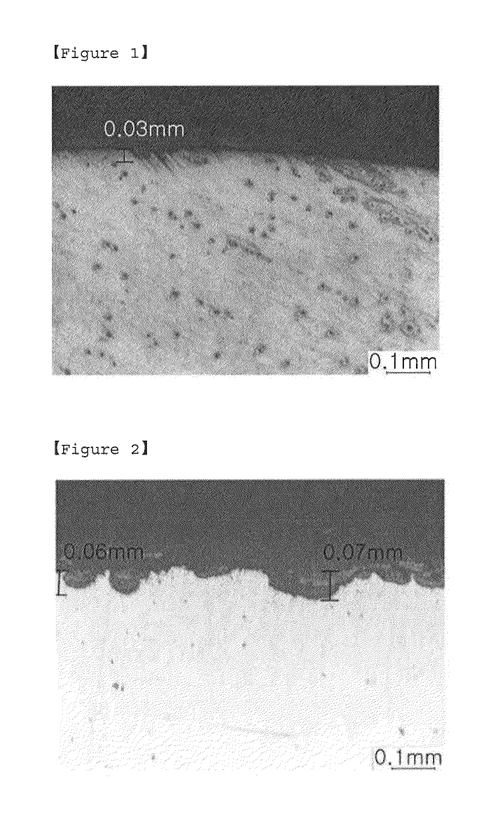

FIGS. 1 and 2 are images showing the depths of corrosion pits formed in Inventive Steel 2 and Comparative Steel 2 after a salt-water corrosion test. The depths of corrosion pits were relatively shallow in the inventive steels as shown in FIG. 1.

1. A wire rod for springs having high corrosion resistance, the wire rod comprising, by weight %, C: 0.45% to 0.6%, Si: 1.0% to 3.0%, Mn: 17.0% to 25.0%, and the balance of Fe and inevitable impurities.

2. The wire rod of claim 1, further comprising, by weight %, Cr: 0.01% to 1.0%.

3. The wire rod of claim 1, wherein the wire rod has a microstructure comprising 99 volume % or more of austenite.

4. A steel wire for springs having high corrosion resistance, the steel wire comprising, by weight %, C: 0.45% to 0.6%, Si: 1.0% to 3.0%, Mn: 17.0% to 25.0%, and the balance of Fe and inevitable impurities.

5. The steel wire of claim 4, further comprising, by weight %, Cr: 0.01% to 1.0%.

6. The steel wire rod of claim 4, wherein the steel wire has a composite microstructure of modified austenite and martensite.

7. A method of manufacturing a steel wire for springs having high corrosion resistance, the method comprising drawing the wire rod of claim 1 to form a steel wire having a tensile strength of 1800 MPa to 2100 MPa and a reduction of area of 25% or greater.

8. A method of manufacturing springs having high corrosion resistance, the method comprising:
drawing the wire rod of claim 1 to form a steel wire having a tensile strength of 1800 MPa to 2100 MPa and a reduction of area of 25% or greater; and
cold-working the steel wire at room temperature.
